(19) United States
(12) Patent Application Publication
(10) Pub. No.: US 2025/0008523 A1
(43) Pub. Date: Jan. 2, 2025

(54) TRANSMISSION AND RECEPTION OF PDCCH REPETITIONS

(71) Applicant: Nokia Technologies Oy, Espoo (FI)

(72) Inventors: Bo BI, Hangzhou (CN); Alessio MARCONE, Munich (DE); Arman AHMADZADEH, Munich (DE); Frank FREDERIKSEN, Aalborg (DK)

(21) Appl. No.: 18/749,125

(22) Filed: Jun. 20, 2024

(30) Foreign Application Priority Data
Jun. 30, 2023 (WO) PCT/CN2023/105299

(51) Int. Cl. H04W 72/231; H04W 56/00; H04W 72/0446

(52) U.S. Cl. CPC H04W 72/231; H04W 56/0015; H04W 72/0446

(57) ABSTRACT

Example embodiments of the present disclosure relate to apparatuses, methods, and computer readable storage medium for transmission and reception of physical control channel (PDCCH) repetitions. In a method, a user device determines a repetition pattern associated with repetitions of a PDCCH transmission. The repetition pattern is configured in at least one slot in one or more frames. The user device monitors the repetitions of the PDCCH transmission based on the repetition pattern. Then, the user device decodes control information based on at least one monitored repetition of the repetitions of the PDCCH transmission.

### FIELDS

Various example embodiments of the present disclosure generally relate to the field of telecommunication and in particular, to apparatuses, methods and computer readable storage medium for transmission and/or reception of physical control channel (PDCCH) repetitions.

### BACKGROUND

In the third-generation partnership project (3GPP) Release 18 (Rel-18), it is studied for non-terrestrial networks (NTNs) to apply solutions developed by new radio (NR) coverage enhancements to NTNs, and to identify potential issues and enhancements, considering NTN characteristics including large propagation delay and satellite movement. In a preliminary study phase, coverage performance of different uplink (UL) and downlink (DL) channels is assessed, and the bottleneck channels are identified. Such identification leads to the objectives for NTNs to specify physical uplink control channel (PUCCH) enhancements for Message 4 (Msg4) hybrid automatic repeat request (HARQ)-acknowledgement (ACK) (e.g., repetitions) and to study demodulation reference signal (DMRS) bundling for a physical uplink shared channel (PUSCH) taking NTN-specifics (e.g., time-frequency pre-compensation) into account and, if necessary, to specify enhancements to Release 17 (Rel-17) procedures. Some DL channels need enhancements as well.

### SUMMARY

In a first aspect of the present disclosure, there is provided a user device. The user device comprises at least one processor; and at least one memory storing instructions that, when executed by the at least one processor, cause the user device at least to: determine a repetition pattern associated with repetitions of a physical downlink control channel (PDCCH) transmission; monitor the repetitions of the PDCCH transmission based on the repetition pattern; and decode control information based on at least one monitored repetition of the repetitions of the PDCCH transmission. The repetition pattern is configured in at least one slot in one or more frames.

In a second aspect of the present disclosure, there is provided a network device. The network device comprises at least one processor; and at least one memory storing instructions that, when executed by the at least one processor, cause the network device at least to: determine a repetition pattern associated with repetitions of a PDCCH transmission; and transmit the repetitions of the PDCCH transmission based on the repetition pattern. The repetition pattern is configured in at least one slot in one or more frames.

In a third aspect of the present disclosure, there is provided a method. The method comprises determining a repetition pattern associated with repetitions of a PDCCH transmission; monitoring the repetitions of the PDCCH transmission based on the repetition pattern; and decoding control information based on at least one monitored repetition of the repetitions of the PDCCH transmission. The repetition pattern is configured in at least one slot in one or more frames.

In a fourth aspect of the present disclosure, there is provided a method. The method comprises determining a repetition pattern associated with repetitions of a PDCCH transmission; and transmitting the repetitions of the PDCCH transmission based on the repetition pattern. The repetition pattern is configured in at least one slot in one or more frames.

In a fifth aspect of the present disclosure, there is provided a first apparatus. The first apparatus comprises means for determining a repetition pattern associated with repetitions of a PDCCH transmission, the repetition pattern being configured in at least one slot in one or more frames; means for monitoring the repetitions of the PDCCH transmission based on the repetition pattern; and means for decoding control information based on at least one monitored repetition of the repetitions of the PDCCH transmission.

In a sixth aspect of the present disclosure, there is provided a second apparatus. The second apparatus comprises means for determining a repetition pattern associated with repetitions of a PDCCH transmission, the repetition pattern being configured in at least one slot in one or more frames; and means for transmitting the repetitions of the PDCCH transmission based on the repetition pattern.

In a seventh aspect of the present disclosure, there is provided a computer readable medium. The computer readable medium comprises instructions stored thereon for causing an apparatus to perform at least the method according to the third or fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling diagram for an example communication process in accordance with some example embodiments of the present disclosure;

FIG. 3A illustrates an example configuration of the repetition pattern in accordance with some example embodiments of the present disclosure;

FIG. 3B illustrates an example configuration of the repetition pattern in accordance with some other example embodiments of the present disclosure;

FIG. 3C illustrates another example configuration of a repetition pattern in accordance with some embodiments of the present disclosure;

FIG. 3D illustrates a further example configuration of a repetition pattern in accordance with some embodiments of the present disclosure;

FIG. 3E illustrates example deployment of search space sets in a slot according to some example embodiments of the present disclosure;

FIG. 4 illustrates example grouping of PDCCH candidates with aggregation level (AL) 4 in accordance with some example embodiments of the present disclosure;

FIG. 5 illustrates an example process for reception of PDCCH repetitions in accordance with some example embodiments of the present disclosure;

FIG. 6 illustrates a flow chart of an example method for reception of PDCCH repetitions in accordance with some example embodiments of the present disclosure;

FIG. 7 illustrates a flow chart of another example method for reception of PDCCH repetitions in accordance with some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user device”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, in Rel-18, the coverage enhancement to NTNs is focused mostly on UL enhancements, e.g., on enhancements of the Msg4 HARQ-ACK and enhancements to the DMRS bundling framework for PUSCH. However, some DL channels need enhancements as well. When considering satellite power limitations (due to for example regulatory requirements or power split among beams of satellites), the channels related to an initial access need to be enhanced for downlink coverage enhancements. Such channels may include a physical downlink control channel (PDCCH), a physical downlink shared channel (PDSCH) for Message 2 (Msg2) and a PDSCH for Msg4. For example, when considering power flux density (PFD) limits or more generically limits on satellite output power, coverage enhancements for a PDCCH are needed to improve channel performance.

For improving coverage, the following approaches may be considered: (a) lowering the interference and noise contributions, (b) increasing the transmission power, and (c) increasing the energy per bit (through either reducing the payload or transmitting over longer time). However, the approach (a) is not relevant for the PDCCH enhancements, and the approach (b) are not possible due to the PFD limits. The approach (c) may be achieved by introducing repetitions of the channel to be enhanced. For example, for improving the physical layer performance of a channel, a larger number of resources may be assigned to the data or control channel transmission for a certain number of bits (in case of data and/or control channel). One approach to achieve this is to repeat of the transmission of the payload data multiple times, to give the possibility to a receiver to combine the received signals and improve the reliability of the demodulated and decoded bits.

In Rel-17, the repetition of UE specific search space (USS) PDCCH has been specified for a multi-transmission and reception point (TRP) feature, and such a mechanism may be extended for NTNs, at least for the PDCCHs in a radio resource control (RRC) connected mode. However, the repetition feature does not apply to the PDCCH in an initial access and, specifically, to Type0-PDCCH configured. In the enhancements of the coverage of Type0-PDCCH, Type0-PDCCH may be repeated multiple times in a same or different slot, thereby allowing a UE to combine the received Type0-PDCCH transmissions.

However, in order to be able to combine the multiple Type0-PDCCH repetitions, it is necessary for the UE to know at least if and how many repetitions are being transmitted by a gNB, and hence a time span of the Type0-PDCCH repetitions. There is a need for designs of reception and monitoring for Type0-PDCCH with repetitions.

Example embodiments of the present disclosure propose a framework for reception of PDCCH repetitions. In this framework, a repetition pattern associated with a plurality of repetitions of a PDCCH (such as Type0-PDCCH) transmission is configured in at least one slot in one or more frames. Based on such a repetition pattern, a user device monitors the repetitions of the PDCCH transmission (also referred to as PDCCH repetitions) and decodes control information based on the monitored repetition(s).

In an example, the monitoring and decoding may be performed based on one or more configurations related to PDCCH repetitions, which may include a number of repetitions or a repetition factor, or a trigger of a specified number of PDCCH repetitions. Based on the proposed framework, the user device may know how to operate when a PDCCH is configured with repetitions. As such, the PDCCH repetition may be received in a more efficient way, and thus PDCCH coverage enhancements may be achieved effectively and efficiently.

It is to be noted that although the proposed scheme is originating from an NTN scenario, the proposed scheme herein may be applied in general for any deployment scenario. In the following, some example embodiments will be described using Type0-PDCCH as an example implementation of a PDCCH while the example embodiments herein can be applied in general for any other types of PDCCHs. Moreover, some example embodiments will be described using PDCCH repetitions as an example implementation of PDCCH resource extensions for PDCCH coverage enhancements while the example embodiments herein can be applied in general for any other types of PDCCH resource extensions. For example, PDCCH resource extension can also refer to a PDCCH channel transmitted over multiple slots, or a PDCCH channel transmitted over a number of OFDM symbols larger than 3 (where 3 symbols are the current maximum size of a CORESET for PDCCH transmission).

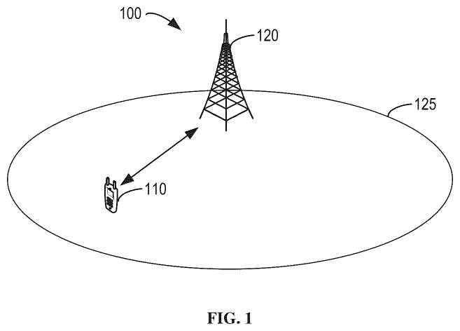

FIG. 1 shows an example communication environment 100 in which example embodiments of the present disclosure can be implemented.

In the communication environment 100, a plurality of communication devices, comprising a user device 110 and a network device 120, can communicate with each other. The network device 120 may serve a coverage area, called a cell 125. The user device 110 may have access to a communication network via the cell 125. In some example embodiments, both the user device 110 and the network device 120 may be configured to implement a beamforming technique and communicate with each other via a plurality of beams.

In some example embodiments, a link from the network device 120 to the user device 110 is referred to as a DL, while a link from the user device 110 to the network device 120 is referred to as a UL. In DL, the network device 120 is a Tx device (or a transmitter), and the user device 110 is a Rx device (or a receiver). In UL, the user device 110 is a Tx device (or a transmitter), and the network device 120 is a Rx device (or a receiver). A link between the user device 110 and another user device (not shown) is referred to as a sidelink (SL). In SL, one of the user devices is a Tx device (or a transmitter), and the other of the user devices is a Rx device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connections are shown in FIG. 1 only for the purpose of illustration without suggesting any limitation. The communication environment 100 may include any suitable number of devices configured to implement example embodiments of the present disclosure.

In some example embodiments, during cell search, the user device 110 may determine a control resource set (CORESET) and a search space (e.g., a time domain location) for Type0-PDCCH from a master information block (MIB) message from the network device 120. For example, the user device 110 may determine from MIB that a CORESET for Type0-PDCCH common search space (CSS) set (also referred to as CORESET #0 or CORESET 0) is present. The user device 110 may also determine a number of consecutive resource blocks and a number of consecutive symbols for the CORESET of the Type0-PDCCH CSS set from controlResourceSetZero in pdcch-ConfigSIB1, included in MIB, for operation without a shared spectrum channel access in frequency range 1 (FR1) and frequency range 2-1 (FR2-1), or for operation with a shared spectrum channel access in FR1 and frequency range 2-2 (FR2-2) and determine PDCCH monitoring occasions (PMOs) from searchSpaceZero in pdcch-ConfigSIB1.

The Type0-PDCCH CSS set may be defined by control channel element (CCE) aggregation levels and the number of PDCCH candidates per CCE aggregation level as given in Table 1, which may be configured by searchspaceSIB1.

TABLE 1

| CCE Aggregation Level | Number of Candidates |
|---|---|
| 4 | 4 |
| 8 | 2 |
| 16 | 1 |

The Type0-PMOs is specified in the 3GPP standards, such as TS 38.213. For operation without a shared spectrum channel access and for a synchronization signal and physical broadcast channel (PBCH) block (SSB or SS/PBCH block) and CORESET multiplexing pattern 1, the user device 110 may monitor a PDCCH in the Type0-PDCCH CSS set over two slots. For an SS/PBCH block with an index i, the user device 110 may determine a slot number of slot n₀ as n₀=(O·2^{μ}+ └i·M┘) mod N_{slotframe,μ}, which is in a frame with a system frame number (SFN), denoted by SFNc satisfying SFNc mod 2=0 if └(O·2^{μ}+└i·M┘)/N_{slotframe,μ}┘ mod 2=0, or in a frame with a SFN satisfying SFNc mod 2=1 if └(O·2^{μ}+└i·M┘)/N_{slotframe,μ}┘ mod 2=1 where μ∈{0, 1, 2, 3, 5, 6} based on the SCS for PDCCH receptions in the CORESET. Herein, mod, also called Modulo, is an operation that finds the remainder when one integer is divided by another.

For μ∈{0, 1, 2, 3} and for a SS/PBCH block index i, the two slots including the associated Type0-PMOs are slots n₀ and n₀+1. M, O, and the index of the first symbol of the CORESET in slots n₀ and n₀+1 may be provided in Table 2.

TABLE 2

| | | Number of search | | First |
|---|---|---|---|---|
| No. | O | space sets per slot | M | symbol index |
| 0 | 0 | 1 | 1 | 0 |
| 1 | 0 | 2 | 1/2 | {0, if i is even}, |
| | | | | {N_{symb}^{CORESET}, |
| | | | | if i is odd} |
| 2 | 2 | 1 | 1 | 0 |
| 3 | 2 | 2 | 1/2 | {0, if i is even}, |
| | | | | {N_{symb}^{CORESET}, |
| | | | | if i is odd} |
| 4 | 5 | 1 | 1 | 0 |
| 5 | 5 | 2 | 1/2 | {0, if i is even}, |
| | | | | {N_{symb}^{CORESET}, |
| | | | | if i is odd} |
| 6 | 7 | 1 | 1 | 0 |
| 7 | 7 | 2 | 1/2 | {0, if i is even}, |
| | | | | {N_{symb}^{CORESET}, |
| | | | | if i is odd} |
| 8 | 0 | 1 | 2 | 0 |
| 9 | 5 | 1 | 2 | 0 |
| 10 | 0 | 1 | 1 | 1 |
| 11 | 0 | 1 | 1 | 2 |
| 12 | 2 | 1 | 1 | 1 |
| 13 | 2 | 1 | 1 | 2 |
| 14 | 5 | 1 | 1 | 1 |
| 15 | 5 | 1 | 1 | 2 |

For μ∈{0, 1} and for a candidate SS/PBCH block index i, the two slots including the associated Type0-PMOs are slots n₀ and n₀+1. The user device 110 may not expect to be configured with M=1/2, or with M=2, when N=1. For μ=3 and for a candidate SS/PBCH block index i, the two slots including the associated Type0-PMOs are also slots n₀ and n₀+1. For μ=5 and for a candidate SS/PBCH block index i, the two slots including the associated Type0-PMOs are slots n₀ and n₀+4. For μ=6 and for a candidate SS/PBCH block index i, the two slots including the associated Type0-PMOs are slots n₀ and n₀+8.

If sub-carrier spacing (SCS) is taken, for example, as 30 kHz for both the PDCCH and the SSB, the PMO associated with SSB index i may be calculated as shown in Table 3.

TABLE 3

| No. | O | M | n₀(i = 0) | n₀(i = 1) | n₀(i = 2) | n₀(i = 3) | n₀(i = 4) | n₀(i = 5) | n₀(i = 7) | n₀(i = 7) |
|---|---|---|---|---|---|---|---|---|---|---|
| 0 | 0 | 1 | 0 | 1 | 2 | 3 | 4 | 5 | 6 | 7 |
| 1 | 0 | 1/2 | 0 | 0 | 1 | 1 | 2 | 2 | 3 | 3 |
| 2 | 2 | 1 | 4 | 5 | 6 | 7 | 8 | 9 | 10 | 11 |
| 3 | 2 | 1/2 | 4 | 4 | 5 | 5 | 6 | 6 | 7 | 7 |
| 4 | 5 | 1 | 10 | 11 | 12 | 13 | 14 | 15 | 16 | 17 |
| 5 | 5 | 1/2 | 10 | 10 | 11 | 11 | 12 | 12 | 13 | 13 |
| 6 | 7 | 1 | 14 | 15 | 16 | 17 | 18 | 19 | 0 | 1 |
| 7 | 7 | 1/2 | 14 | 14 | 15 | 15 | 16 | 16 | 17 | 17 |
| 8 | 0 | 2 | 0 | 2 | 4 | 6 | 8 | 10 | 12 | 14 |
| 9 | 5 | 2 | 10 | 12 | 14 | 16 | 18 | 0 | 2 | 4 |
| 10 | 0 | 1 | 0 | 1 | 2 | 3 | 4 | 5 | 6 | 7 |
| 11 | 0 | 1 | 0 | 1 | 2 | 3 | 4 | 5 | 6 | 7 |
| 12 | 2 | 1 | 4 | 5 | 6 | 7 | 8 | 9 | 10 | 11 |
| 13 | 2 | 1 | 4 | 5 | 6 | 7 | 8 | 9 | 10 | 11 |
| 14 | 5 | 1 | 10 | 11 | 12 | 13 | 14 | 15 | 16 | 17 |
| 15 | 5 | 1 | 10 | 11 | 12 | 13 | 14 | 15 | 16 | 17 |

In the configurations of PMOs, the index is numbered as #0 through #15, as shown in Table 3, if the configuration with index #4 is taken as an example, slot n₀+1 of the previous beam (e.g., with SSB index 0) and slot no of the next beam (e.g., with SSB index 1) are overlapped due to M=1. The overlapping slots may carry at most one CORESET for one SSB index. The PMOs may comprise all possible PMOs.

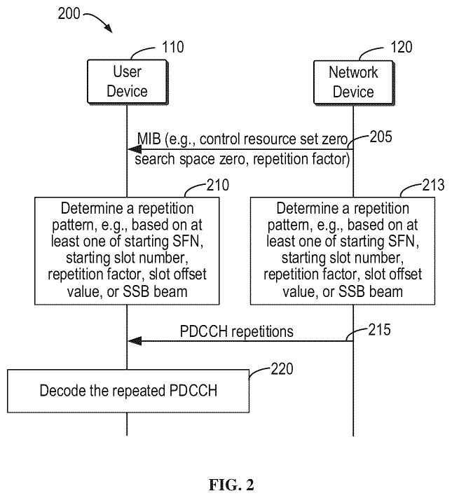

In some example embodiments, at least one configuration associated with Type0-PDCCH repetitions may be conveyed via the MIB message from the network device 120 to the user device 110. Based on the configuration, the user device 110 may perform monitoring, reception and blind decoding for Type0-PDCCH repetitions. In various example embodiments, the monitoring, reception and blind decoding is performed based on a repetition pattern which is configured in at least one slot in one or more frames. Some example implementations will be discussed below with reference to FIG. 2.

FIG. 2 illustrates a signaling diagram for an example communication process 200 between the user device 110 and the network device 120 according to some example embodiments of the present disclosure.

As shown in FIG. 2, the network device 120 may transmit (205) a MIB message to the user device 110. The MIB message may contain a control resource set zero field and a search space zero field, which may be carried in the pdcch-ConfigSIB1 information element. Accordingly, the UE 310 may know frequency domain resources from the control resource set zero field and time domain resources from the search space zero field. The MIB message may contain a repetition factor or any other configuration information associated with the PDCCH repetitions. After receiving such MIB, the user device 110 may know that the PDCCH repetitions are enabled and know the configuration of the PDCCH repetitions.

Then, the user device 110 may determine (210) a repetition pattern associated with the PDCCH repetitions. The repetition pattern may focus on one PDCCH transmission and corresponding repetitions. The repetition pattern may be determined based on at least one of: a repetition factor, a starting symbol number, a starting slot number, a starting frame number, a slot offset value, a frame offset value, or an index of a SSB beam.

In some example embodiments, the repetition pattern may be determined (213) and/or configured by the network device 120 to the user device 110. For example, the network device 120 may transmit at least one configuration associated with the repetition pattern to the user device 110 to indicate what or which repetition pattern is used for the PDCCH repetitions. For example, the network device 120 may configure one or more repetition patterns, then transmit configuration information configuring the repetition pattern to the user device 110. In another example, one or more repetition patterns are hardcoded in the specifications. The network device 120 may select one of predetermined repetition patterns depending on some conditions, e.g., configuration of CORESET, Search Space and/or Type0-PDCCH repetition factor, and then the network device 120 may transmit an indication indicating the specific repetition pattern to the user device 110.

The repetition pattern may be configured in at least one slot in one or more frames. The at least one slot may have at least one slot number. The at least one slot number may comprise a slot number (referred to as a first slot number) indicating the starting slot number for the plurality of repetitions of the PDCCH transmission, and/or a slot number (referred to as a second slot number) with the offset value with respect to the first slot number. The repetition pattern is configured in slots having the first slot number and/or the second slot number in the one or more frames. The frame and slot structures may be referred to TS38.211 standard documents. For example, one frame comprises one or more slots, and one slot comprises one or more symbols (e.g., 14 symbols). In this case, each frame has the same number of slots if the SCS value is the same, and the slot number is started from 0 in each of the frames.

By way of example, if the user device 110 is capable of Type0-PDCCH with repetitions and receives from the network device 120 the MIB message with the configured repetition factor or with selection of one repetition pattern, the user device 110 may receive Type0-PDCCH in a repetition way across multiple slots. In some example embodiments, the Type0-PDCCH repetitions may occur in slot no or in slot n₀+1 or n₀+x in a plurality of frames, the plurality of frames denoted by SFNc, where x represents a positive integer and n₀+x represents a slot with a slot offset value x with respect to slot n₀, wherein n₀ may be determined as already described above.

In some example embodiments, the one or more frames the repetition pattern may be configured in may have one or more frame numbers. The one or more frame numbers may comprise a first frame number indicating the starting frame number for the repetitions of the PDCCH transmission, and/or a second frame number with a frame offset value with respect to the first frame number.

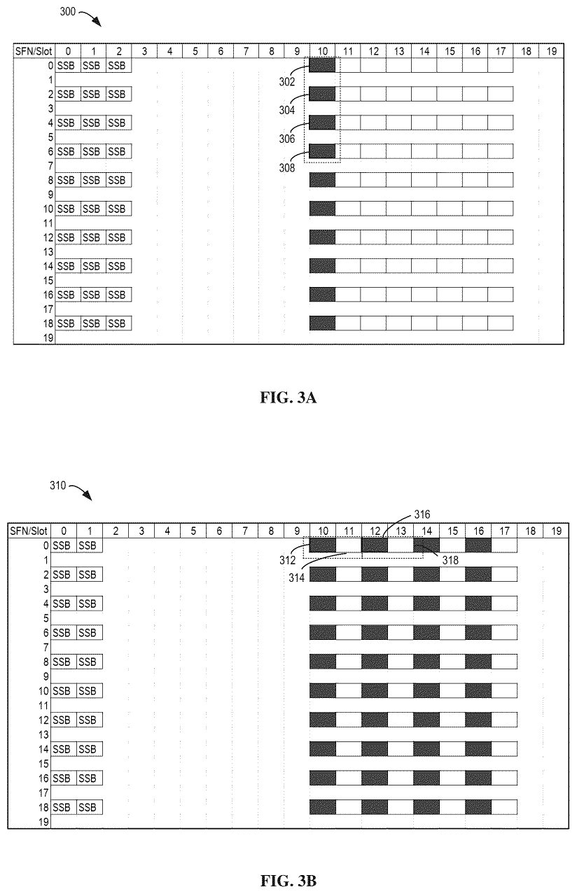

An example configuration of the repetition pattern is shown in FIG. 3A. In this example, the repetition factor is 4 for SSB index 0 in slot n₀ (n₀=10 in this case) in a plurality of frames SFNc. The PDCCH repetitions may be received across a SFN span in the repetition way.

In a configuration 300 as shown in FIG. 3A, the repetition pattern is configured in a slot in four frames according to the repetition factor. In an example, repetition occasions 302, 304, 306 and 308 may follow the slot occasions corresponding to a SSB beam in configuration index #4 of PMOs in Table 3, e.g., no, which is the starting slot number for the PDCCH repetitions in each frame. n₀ may be predefined or specified in the 3GPP standards. In this example, the repetition pattern may be configured in a group of frames with the frame offset value 2, e.g., (SFNₛₜₐᵣₜ, SFNₛₜₐᵣₜ+2, . . . , SFNₛₜₐᵣₜ+N*2), hence in alternate SFNs (e.g., even SFNs or odd SFNs). N represents the repetition factor or more generically the extension factor of the PDCCH in number of slots. SFNₛₜₐᵣₜ represents the system frame number of the frame where the PDCCH repetitions (or extended PDCCH) start. In some embodiment, SFNₛₜₐᵣₜ is indicated by the configuration or determined by the user device 110.

The repetitions may be transmitted in the repetition pattern in slot granularity, e.g., in the group of slots in frame candidates as below:
n₀^{SFN}^{ₛₜₐᵣₜ}, n₀^{SFN}^{ₛₜₐᵣₜ}⁺², . . . , n₀^{SFN}^{ₛₜₐᵣₜ}^{+2*N})
   where n₀^{SFN}^{ₛₜₐᵣₜ} represents slot n₀ in a frame of SFNₛₜₐᵣₜ, n₀^{SFN}^{ₛₜₐᵣₜ}^{+2*N} represents slot n₀ in a frame of SFNₛₜₐᵣₜ+2*N, and so on.

In other example embodiments, the repetition occasions may follow the slot monitoring occasion n₀+1, or n₀+x, which may be the starting slot number for the PDCCH repetitions in each frame. The repetitions are transmitted in a repetition pattern for slot granularity which is the group of slots in frame candidates as below:

$$( {n}_{0}^{{SFN}_{start}} + x , {n}_{0}^{{SFN}_{start} + 2} + x , … … , {n}_{0}^{{SFN}_{start} + 2 * N} + x ) ,$$

where n₀^{SFN}^{ₛₜₐᵣₜ}+x represents slot n₀+x in a frame of SFNₛₜₐᵣₜ, n₀^{SFN}^{ₛₜₐᵣₜ}^{+2*N}+x represents slot n₀+x in a frame of SFNₛₜₐᵣₜ+2*N, and so on. For example, x may be 1, 4 or 8 depending on the Sub-carrier Spacing (SCS) value u as described above.

In some example embodiments, the starting frame number, SFNₛₜₐᵣₜ, may be determined as SFNc in a predetermined time window. The predetermined time window may have predetermined duration and start from a reference frame having a system frame number SFN_{reference}, which may be SFN₀ (or SFN=0) for SSB indexes with PMOs in even SFNs or SFN₁ (or SFN=1) for SSB indexes with PMOs in odd SFNs.

In some example embodiments, the starting frame number, SFNₛₜₐᵣₜ, of the one or more frames may be determined based on a predetermined periodicity and a reference frame. The predetermined periodicity may be associated with a number of frames for the repetitions of the PDCCH transmission (or for the PDCCH extension) that may depend on the repetition factor. In an example, the number of frames for the PDCCH repetitions may be equal to the configured number of repetitions or the repetition factor. In another example, the periodicity may be equal to two times the configured number of repetitions or the repetition factor considering that PMOs occur at alternate SFN values (e.g., even SFNs or odd SFNs). In some embodiments, the periodicity is configured by the network, and may be equal to a value smaller or larger than two times the configured number of repetitions. The reference frame may be determined at the user device 110 as a specified value, based at least on the SSB index selected by the user device 110. For example, the reference frame may be a frame with SFN=0 for SSB indexes with PMOs in even SFNs or SFN=1 for SSB indexes with PMOs in odd SFNs.

In some example embodiments, the periodicity may be predefined in the 3GPP specifications or configured semi-statically or dynamically by the network device 120. In an example, the starting frame number, or SFNₛₜₐᵣₜ, may be determined by the user device 110 at a certain periodicity from the reference frame with system frame number SFN_{reference}, which may be SFN₀ (or SFN=0) for SSB indexes with PMOs in even SFNs or SFN₁ (or SFN=1) for SSB indexes with PMOs in odd SFNs.

In some example embodiments, the starting frame number may be determined as the SFNₛₜₐᵣₜ satisfying:

$$( {SFN}_{start} - {SFN}_{reference} ) mod ( M \times 2 ) = 0.$$

In an example, SFNₛₜₐᵣₜ may satisfy SFNₛₜₐᵣₜ mod (M×2)=0 for SSB indexes with PMOs in even SFNs, or (SFNₛₜₐᵣₜ−1) mod (M×2)=0 for SSB indexes with PMOs in odd SFNs, where M=N in the configuration 300 as shown in FIG. 3A or

$$M = ⌈ \frac{N}{2} ⌉$$

in a configuration as shown in FIG. 3C where the repetition pattern is configured in two slots in each of the one or more frames, as will be described in the following paragraphs. For example, if N=5 and M=3, the SFN={0, 6, 9, . . . }. If N=4 and M=2, then SFN={0, 4, 8, . . . }.

In some example embodiments, the repetition pattern may be configured in a plurality of slots in the one or more frames starting from a slot indicated by the starting slot number. Examples of such a configuration of the repetition pattern will be discussed below with reference to FIGS. 3B and 3C.

FIG. 3B shows an example configuration 310 of the repetition pattern according to some example embodiments of the present disclosure. In this example, the PDCCH repetitions may be transmitted by the network device 120 and received by the user device 110 in the monitoring occasions in slots n₀ and n₀+1, and the repetition factor is 2.

As shown in FIG. 3B, one SSB beam is associated with 2 PMOs in one frame. Thus, each PDCCH associated SSB beam may be received within the same frame in a repetition way. In the configuration 310, two repetition occasions 312 and 314 correspond to a SSB beam, and two repetition occasions 316 and 318 correspond to another SSB beam. For example, in the case that configuration index #8 or #9 of PMOs in Table 3 where 2 consecutive slots for Type0-PDCCH are associated to only one SSB beam, the two slots including the associated PMOs for different SSB beams are not overlapping. In this case, the 2 consecutive slots may be the repetition candidates.

It is to be understood that the use of slots n₀ and n₀+1 as shown in FIG. 3B is only illustrative but not limited. Depending on the configuration of PMOs (e.g., as shown in Table 3) applied, other slot combinations such as slots n₀ and n₀+4 or slots n₀ and n₀+8 may be used as the repetition occasions.

FIG. 3C shows another example configuration 320 of the repetition pattern according to some example embodiments of the present disclosure. Different from the configuration 310 in FIG. 3B, the repetition factor is 4 instead of 2.

In the configuration 320 as shown in FIG. 3C, four repetition occasions 322, 324, 326 and 328 corresponding to a SSB beam are configured in two frames. Thus, each PDCCH associated SSB beam may be received within and across frames in a repetition way.

In the case that 2 slots are used as the repetition occasions in a frame, the repetition pattern may be configured in the group of frames, e.g.,

$$( {SFN}_{start} , {SFN}_{start} + 2 , … … , {SFN}_{start} + ( ⌈ \frac{N}{2} ⌉ - 1 ) * 2 ) ,$$

where N is the configured repetition factor. In an example, the slot of the PDCCH monitoring occasion may be determined by no which may be specified in the 3GPP standards such as TS 38.213, and the repetition occasions may follow the slot occasions corresponding an SSB beam. For example, the starting slot n₀^{SFN}^{ₛₜₐᵣₜ} is n₀ in a frame of SFNₛₜₐᵣₜ. The repetition pattern in slot granularity may be the no group of slots in frame candidates as below:

$$\{ \begin{matrix}( {n}_{0}^{{SFN}_{start}} , {n}_{0}^{{SFN}_{start}} + x , … … , {n}_{0}^{{SFN}_{start + ( ⌈ \frac{N}{2} ⌉ - 1 ) * 2}} , {n}_{0}^{{SFN}_{start + ( ⌈ \frac{N}{2} ⌉ - 1 ) * 2}} + x ) , N is even \\ ( {n}_{0}^{{SFN}_{start}} , {n}_{0}^{{SFN}_{start}} + x , {n}_{0}^{{SFN}_{start} + 2} , {n}_{0}^{{SFN}_{start} + 2} + x , … … , {n}_{0}^{{SFN}_{start + ( ⌈ \frac{N}{2} ⌉ - 1 ) * 2}} + x ) , N is odd\end{matrix} ,$$

where

$${n}_{0}^{{SFN}_{start + ( ⌈ \frac{N}{2} ⌉ - 1 ) * 2}}$$

represents slot no in a frame of

$${SFN}_{start} + ( ⌈ \frac{N}{2} ⌉ - 1 ) * 2$$

if slot n₀+x can be a repetition occasion in the case that slot n₀+x is not overlapped with the slot of the next SSB beam.

In some example embodiments, the repetition pattern is configured in a plurality of search space sets within a slot having the first or second slot number (e.g., n₀ or n₀+1) in each of the one or more frames. A search space set defines a set of resource groups including time/frequency domain resources for monitoring the PDCCH transmission. A search space set may refer to a subset of a search space, identifying different time (symbols) resources in the search space for Type0-PDCCH of an associated specific SSB. Examples of such a configuration of the repetition pattern will be discussed below with reference to FIGS. 3D and 3E.

FIG. 3D shows an example configuration 330 of the repetition pattern according to some example embodiments of the present disclosure. In this example, the number of search space sets per slot is 2, and the repetition factor is 2. A PMO of a Type0-PDCCH CSS set is identified by different time (symbols) resources in the search space set for Type0-PDCCH of an associated specific SSB. In the example, such as FIG. 3D, the number of Search Space set is 2, the Type0-PDCCH CSS set monitoring occasions in different slots and associated to a same specific SSB index belong to the same repetition pattern, e.g., repetition occasion 332 and 336 belong to one repetition pattern associated to one SSB and repetition occasion 334 and 338 belong to the other repetition pattern associated to another SSB.

In an example, a Type0-PDCCH CSS set may be one of 2 search space sets in the same slot, which may follow for example configuration index #7 of PMOs in Table 3. The 2 search space sets may be associated to 2 SSB indexes in a slot. In this case, the repetition occasions may be configured in one of the search space sets corresponding to one SSB index. As shown in FIG. 3D, in the configuration 330, repetition occasions 332 and 334 are configured in one search space set corresponding to an SSB in a slot (e.g., slot #14) across two frames, and repetition occasions 336 and 338 are configured in other two monitoring occasions in the same slot across the same two frames but in different OFDM symbols of the slot corresponding to another SSB.

FIG. 3E shows an example of a plurality of search space sets in a slot according to some example embodiments of the present disclosure. As shown in FIG. 3E, in a slot 340 (e.g., slot #14), a first search space set 342 comprises the first two symbols (e.g., symbols #0 and #1), and a second search space set 344 comprises the next two symbols (e.g., symbols #2 and #3). The search space sets 342 corresponds to one SSB beam and the search space set 344 corresponds to the other SSB beam.

Still with reference to FIG. 2, based on the determined (210) repetition pattern, the user device 110 may monitor (215) the PDCCH repetitions. In some example embodiments, the PDCCH repetitions may be monitored per group of PDCCH candidates. A group of PDCCH candidates may comprise PDCCH candidates associated with an aggregation level (AL) with the same candidate index in a plurality of PMOs, the plurality of PMOs determined as described above and belonging to a repetition pattern. In this way, the number of blind decoding may be reduced, thereby reducing the processing complexity and saving processing resources of the user device 110.

For example, within a slot, there may be one or two search space sets (as shown in Table 2). In each PMO of each search space set, there may be 4 PDCCH candidates of AL 4, 2 candidates of AL 8 and 1 candidate of AL 16. In an example, the PDCCH candidates of an AL with same index in the PMOs in the repetition pattern may be linked as a PDCCH group for repeating reception.

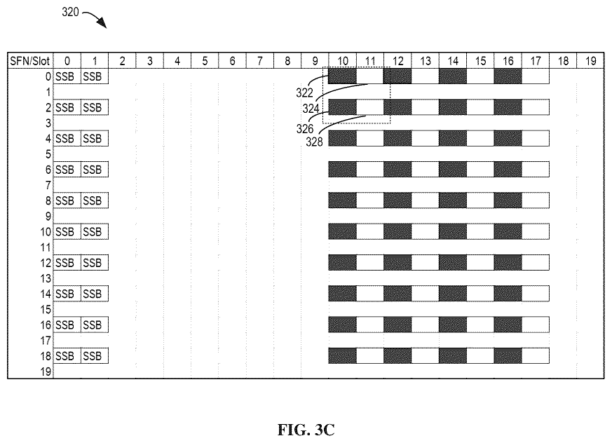

FIG. 4 shows example grouping of PDCCH candidates with AL 4 in accordance with some example embodiments of the present disclosure. In this example, the repetition factor is 4. As shown in FIG. 4, PDCCH candidates of AL 4 with the same index, e.g., Candidate_0, Candidate_1, Candidate_2, or Candidate_3, in Type0-PDCCH CSS set monitoring occasion (or CSS occasions) of a same repetition pattern, e.g., labeled as CSS_occasion0, CSS_occasion1, CSS_occasion2, and CSS_occasion3, are grouped into a PDCCH group. For example, PDCCH candidates with the index Candidate_0 in the four CSS occasions are grouped into PDCCH group 0. PDCCH candidates with the index Candidate_1 in the four CSS occasions are grouped into PDCCH group 1. PDCCH candidates with the index Candidate_2 in the four CSS occasions are grouped into PDCCH group 2. PDCCH candidates with the index Candidate_3 in the four CSS occasions are grouped into PDCCH group 3.

In an example, a group of PMOs denoted as {sⱼ, Sⱼ₊₁, Sⱼ₊₂, . . . , S_{j+N-1}} is associated with monitoring slots in a repetition pattern in SFNs (SFNₛₜₐᵣₜ, SFNₛₜₐᵣₜ+2, . . . , SFNₛₜₐᵣₜ+N*2) where s; represents the jth PMO. A Type0-PDCCH candidate mₛ_{ⱼ}^{(L)}: 0, . . . , Mₛ_{ⱼ}^{(L)}−1, where Mₛ_{ⱼ}^{(L)} represents the number of PDCCH candidates within a PMO sⱼ which the user device 110 is configured to monitor for aggregation level L. To reduce the number of blind decoding, of all the Type0-PDCCH candidates per PMO {mₛ_{ⱼ}^{(L)}, mₛ_{ⱼ₊₁}^{(L)}, mₛ_{ⱼ₊₂}^{(L)}, (L) . . . , mₛ_{ⱼ₊ₙ₋₁}^{(L)}}, the user device 110 may simultaneously monitor PDCCH candidates mₛ_{ⱼ}^{(L)}=mₛ_{ⱼ₊₁}^{(L)}=mₛ_{ⱼ₊₂}^{(L)}= ⋅ ⋅ ⋅=mₛ_{_{j+N-1}}^{(L)}. In other words, the user device 110 may simultaneously monitor PDCCH candidates with a same index across different PMOs that constitute the repetition pattern. These PDCCH candidates are grouped into a PDCCH group.

In another example, the group of PMOs {sⱼ, sⱼ₊₁, sⱼ₊₂, . . . , s_{j+N-1}} of a same repetition pattern is in different slots of a same of different frame. For example, the PMOs could be in slots (n₀^{SPN}^{ₛₜₐᵣₜ}, n₀^{SFN}^{ₛₜₐᵣₜ}+x,n₀^{SFN}^{ₛₜₐᵣₜ}⁺², n₀^{SFN}^{ₛₜₐᵣₜ}⁺²+x, . . . , n₀^{SFN}^{ₛₜₐᵣₜ}^{+2*N}, n₀^{SFN}^{ₛₜₐᵣₜ}^{+2*N}+x), which may include non-overlapping consecutive slot occasion within the same frame as shown in FIG. 3B or across frame occasions as shown in FIG. 3C. The PDCCH candidates of these PMOs may be grouped into different PDCCH groups.

Next, returning to FIG. 2, the user device 110 may decode (220) control information based on at least one monitored PDCCH repetition. In some example embodiments, the user device 110 may decode the repetitions one by one. For example, the user device 110 may decode each Type0-PDCCH repetition separately until Type0-PDCCH is successfully decoded, which is called selective decoding (SD) and may exploit the time diversity gain.

In some example embodiments, the user device 110 may decode the PDCCH transmission based on the plurality of repetitions. In an example, the user device 110 may combine all the Type0-PDCCH repetitions before decoding the Type0-PDCCH, which is called soft combining and thus may exploit the combining gain with multiple receptions. To support soft combining (or chase combining), the content of each transmission of PDCCH repetition may need to keep the same as the 1st transmission.

In some example embodiments, the user device 110 may decode the PDCCH transmission based on the monitored repetition and at least one previously monitored repetition. For example, the user device 110 may combine the Type0-PDCCH repetitions one by one, and each combination is associated to one time decoding until the Type0-PDCCH is successfully decoded. In this case, the content of each transmission of PDCCH repetition also needs to keep the same as the 1st transmission.

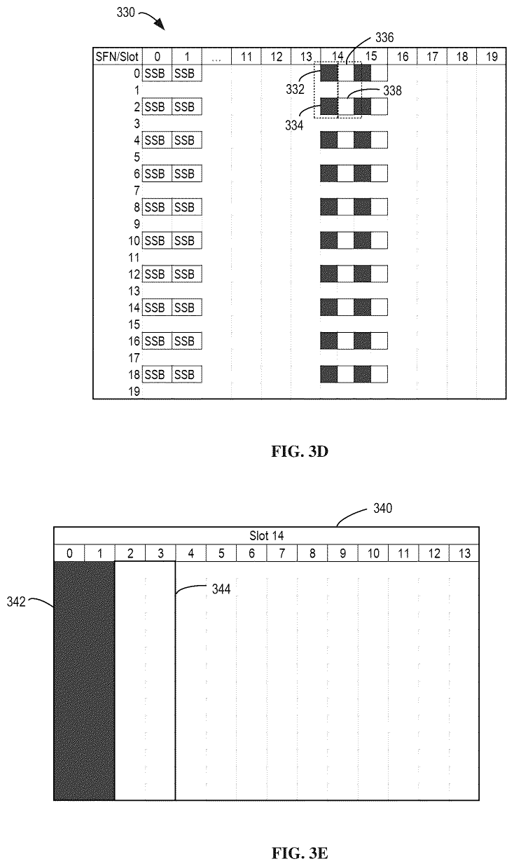

An example process of Type0-PDCCH configuration, monitoring and reception will be described below with reference to FIG. 5.

In a process 500 as shown in FIG. 5, the user device 110 may be configured (502) from the network device 120 via MIB with a repetition factor (N repetitions in this example) for Type0-PDCCH as well as ControlResourceSetZero field, SearchSpaceZero field, and/or the like. Then, the user device 110 may know that the repetition is enabled and get the repetition factor, e.g., 4 from repurposed bits of spare and cellBarred fields in MIB, for example. Moreover, the user device 110 may know frequency domain resources from ControlResourceSetZero field and time domain resources from SearchSpaceZero field in MIB. Then, the UE 305 may start monitoring repetitions.

As shown in FIGS. 5, at 504, 508, 512, and 516, the user device 110 may start monitoring each repetition occasion belonging to the repetition pattern as configured by the network device 120. In an example, the repetition pattern spans frames (SFNₛₜₐᵣₜ, SFNₛₜₐᵣₜ+2, SFNₛₜₐᵣₜ+N*2), where N is the repetition factor and in the slot of (n₀^{SFN}^{ₛₜₐᵣₜ}, n₀^{SFN}^{ₛₜₐᵣₜ}⁺², . . . , n₀^{SFN}^{ₛₜₐᵣₜ}^{+2*N}) or (n₀^{SFN}^{ₛₜₐᵣₜ}, n₀^{SFN}^{ₛₜₐᵣₜ}+1, n₀^{SFN}^{ₛₜₐᵣₜ}⁺², n₀^{SFN}^{ₛₜₐᵣₜ}⁺²⁺¹, . . . , n₀^{SFN}^{ₛₜₐᵣₜ}^{+2*N}, n₀^{SFN}^{ₛₜₐᵣₜ}^{+2*N}+1) within the corresponding SFN, where n₀^{SFN}^{ₛₜₐᵣₜ}^{+2+N} is the n₀ in frame of SFNₛₜₐᵣₜ+2*N and N is repetition factor. In some example embodiments, the user device 110 may monitor the repetitions per group of repetition candidates, which may comprise Type0-PDCCH candidates {mₛ_{ⱼ}^{(L)}, mₛ_{ⱼ₊₁}^{(L)}, mₛ_{ⱼ₊₂}^{(L)}, . . . , mₛ_{_{j+N-1}}^{(L)}}, with mₛ_{ⱼ}^{(L)}=mₛ_{ⱼ₊₁}^{(L)}=mₛ_{ⱼ₊₂}^{(L)}= ⋅ ⋅ ⋅=mₛ_{_{j+N-1}}^{(L)}, where {sⱼ, sⱼ₊₁, sⱼ₊₂, ⋅ ⋅ ⋅ , s_{j+N-1}} are the PMOs of the repetition pattern for the Type0-PDCCH CSS sets in the given slot/SFN.

In an example, after the user device 110 monitors (504) the Type0-PDCCH, the user device 110 may save the received PDCCH transmission in a buffer and does not decode it until receiving all the repetitions at 516. In another example, upon reception (504) of the PDCCH transmission, the user device 110 may try to decode the PDCCH transmission. If the user device 110 decodes it successfully, then the user device 110 will discard the rest of the repetitions. If the user device 110 fails to decode it, then the user device 110 may save it in the buffer. In the case that Selective Decoding (SD) is applied, the user device 110 may monitor (506) SIB1 via a PDSCH.

After the user device 110 monitors (508) the Type0-PDCCH, the user device 110 may also save it in the buffer and does not decode it. Alternatively, the user device 110 may combine the current PDCCH transmission with the PDCCH transmission previously received at 504 and saved in the buffer and start decoding with the combined PDCCH transmissions. If the decoding is successful, then the user device 110 may discard the rest of repetitions. If the user device 110 fails to decode, then the user device 110 may save in the buffer. Similar to 506, the user device 110 may receive (510) SIB1 via a PDSCH if SD is applied. The operations of 512 to 516 are similar to the operations of 504 to 508, and details thereof will be omitted. After all the repetitions are monitored (504, 508, 512 and 516), the user device 110 may receive (518) SIB1 via a PDSCH based on the decoded control information.

It is to be understood that operations described in connection with a user device may be implemented at a network device or other devices, and operations described in connection with a network device may be implemented at a user device or other devices.

### Example Methods

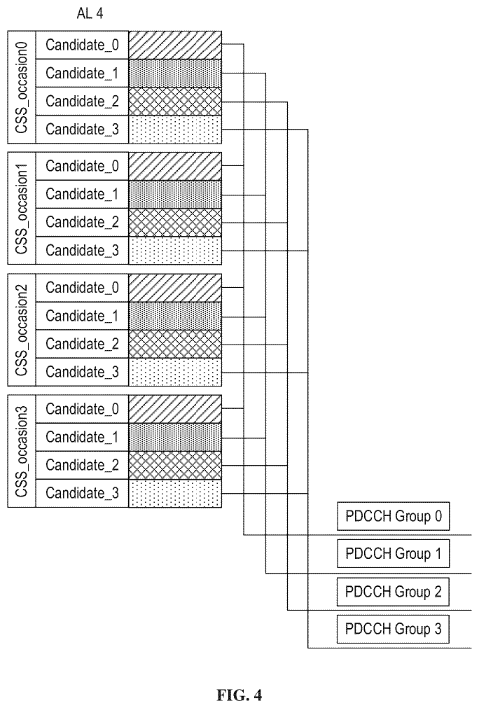

FIG. 6 shows a flowchart of an example method 600 for reception of PDCCH repetitions in accordance with some example embodiments of the present disclosure. The method 600 can be implemented at the user device 110 as shown in FIG. 1. For the purpose of discussion, the method 600 will be described from the perspective of the user device 110 with reference to in FIG. 1.

At block 610, the user device 110 determines a repetition pattern associated with repetitions of a PDCCH transmission. The repetition pattern is configured in at least one slot in one or more frames. At block 620, the user device 110 monitors the repetitions of the PDCCH transmission based on the repetition pattern. At block 630, the user device 110 decodes control information based on at least one monitored repetition of the repetitions of the PDCCH transmission.

In some example embodiments, the repetition pattern may be determined based on at least one of: a repetition factor, a starting symbol number, a starting slot number, a starting frame number, a slot offset value, a frame offset value, or an index of a SSB beam.

In some example embodiments, the at least one slot may have at least one slot number, wherein the at least one slot number comprises at least one of: a first slot number indicating the starting slot number for the repetitions of the PDCCH transmission, or a second slot number with the slot offset value with respect to the first slot number.

In some example embodiments, the repetition pattern may be configured in slots having at least one of the first slot number or the second slot number in the one or more frames.

In some example embodiments, the repetition pattern may be configured in a slot having the first or second slot number in each of the one or more frames.

In some example embodiments, the repetition pattern may be configured in at least one symbol of the slot having the first or second slot number.

In some example embodiments, the first slot number may be predefined.

In some example embodiments, the one or more frames may have one or more frame numbers. The one or more frame numbers may comprise at least one of: a first frame number indicating the starting frame number for the repetitions of the PDCCH transmission, or a second frame number with the frame offset value with respect to the first frame number.

In some example embodiments, the starting frame number of the one or more frames may be determined based on a predetermined periodicity and a reference frame.

In some example embodiments, the reference frame may have a SFN 0 or 1.

In some example embodiments, the predetermined periodicity may be associated with a number of frames for the repetitions of the PDCCH transmission, and the number of frames may depend on the repetition factor.

In some example embodiments, the starting frame number may be determined based on:

$$( {SFN}_{start} - {SFN}_{reference} ) mod ( M \times 2 ) = 0 ,$$

wherein SFNₛₜₐᵣₜ represents the starting frame number, SFN_{reference} represents a system frame number of the reference frame, and M represents the number of frames.

In some example embodiments, the repetition pattern may be configured in two slots in each of the one or more frames, and the number of frames is determined as:

$$M = ⌈ \frac{N}{2} ⌉ ,$$

where M represents the number of frames, and N represents the repetition factor.

In some example embodiments, the user device 110 may receive at least one configuration associated with the repetition pattern.

In some example embodiments, the PDCCH may comprise Type0-PDCCH.

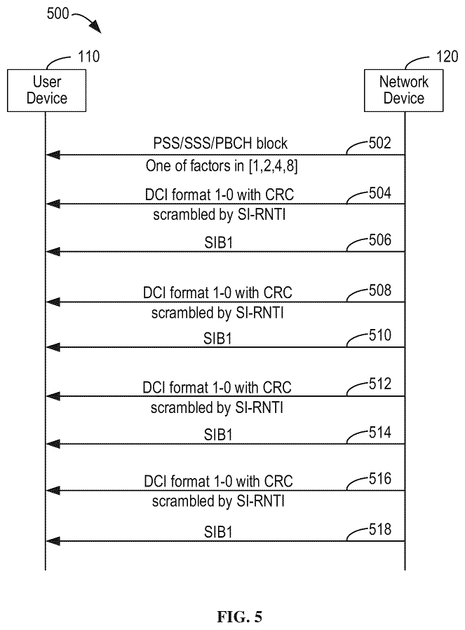

FIG. 7 shows a flowchart of another example method 700 for reception of PDCCH repetitions in accordance with some example embodiments of the present disclosure. The method 700 can be implemented at the network device 120 as shown in FIG. 1. For the purpose of discussion, the method 700 will be described from the perspective of the network device 120 with reference to FIG. 1.

At block 710, the network device 120 determines a repetition pattern associated with repetitions of a PDCCH transmission. The repetition pattern is configured in at least one slot in one or more frames. At block 720, the network device 120 transmits the repetitions of the PDCCH transmission based on the repetition pattern.

In some example embodiments, the repetition pattern may be determined based on at least one of: a repetition factor, a starting symbol number, a starting slot number, a starting frame number, a slot offset value, a frame offset value, or an index of a SSB beam.

In some example embodiments, the at least one slot may have at least one predetermined slot number. The at least one predetermined slot number may comprise at least one of: a first slot number indicating a starting slot number for the repetitions of the PDCCH transmission, or a second slot number with the offset value with respect to the first slot number.

In some example embodiments, the repetition pattern may be configured in slots having at least one of the first slot number or the second slot number in the one or more frames.

In some example embodiments, the repetition pattern may be configured in a slot having the first or second slot number in each of the one or more frames.

In some example embodiments, the repetition pattern may be configured in at least one symbol of the slot having the first or second slot number.

In some example embodiments, the first slot number may be predefined.

In some example embodiments, the one or more frames may have one or more frame numbers. The one or more frame numbers may comprise at least one of: a first frame number indicating the starting frame number for the repetitions of the PDCCH transmission, or a second frame number with the frame offset value with respect to the first frame number.

In some example embodiments, the starting frame number of the one or more frames may be determined based on a predetermined periodicity and a reference frame.

In some example embodiments, the reference frame may have a SFN 0 or 1.

In some example embodiments, the predetermined periodicity may be associated with a number of frames for the repetitions of the PDCCH transmission, and the number of frames may depend on the repetition factor.

In some example embodiments, the starting frame number may be determined based on:

$$( {SFN}_{start} - {SFN}_{reference} ) mod ( M \times 2 ) = 0 ,$$

wherein SFNₛₜₐᵣₜ represents the starting frame number, SFN_{reference} represents a system frame number of the reference frame, and M represents the number of frames.

In some example embodiments, the repetition pattern is configured in two slots in each of the one or more frames, and the number of frames is determined as:

$$M = ⌈ \frac{N}{2} ⌉ ,$$

where M represents the number of frames, and N represents the repetition factor.

In some example embodiments, the network device 120 may transmit at least one configuration associated with the repetition pattern.

In some example embodiments, the PDCCH may comprise Type0-PDCCH.

All operations and features related to the user device 110 and the network device 120 as described above with reference to FIGS. 1 to 5 are likewise applicable to the methods 600 and 700 and have similar effects. For the purpose of simplification, the details will be omitted.

### Example Apparatus, Device and Medium

In some example embodiments, a first apparatus capable of performing the method 600 (for example, the user device 110 in FIG. 1) may comprise means for performing the respective operations of the method 600. The means may be implemented in any suitable form. For example, the means may be implemented in a circuitry or software module. The first apparatus may be implemented as or included in the user device 110 in FIG. 1.

In some example embodiments, the first apparatus comprises means for determining a repetition pattern associated with repetitions of a physical downlink control channel, PDCCH, transmission, wherein the repetition pattern is configured in at least one slot in one or more frames; means for monitoring the repetitions of the PDCCH transmission based on the repetition pattern; and means for decoding control information based on at least one monitored repetition of the repetitions of the PDCCH transmission.

In some example embodiments, the repetition pattern is determined based on at least one of: a repetition factor, a starting symbol number, a starting slot number, a starting frame number, a slot offset value, a frame offset value, or an index of a synchronization signal block, SSB, beam.

In some example embodiments, the at least one slot has at least one slot number, wherein the at least one slot number comprises at least one of: a first slot number indicating the starting slot number for the repetitions of the PDCCH transmission, or a second slot number with the slot offset value with respect to the first slot number.

In some example embodiments, the repetition pattern is configured in slots having at least one of the first slot number or the second slot number in the one or more frames.

In some example embodiments, the repetition pattern is configured in a slot having the first or second slot number in each of the one or more frames.

In some example embodiments, the repetition pattern is configured in at least one symbol of the slot having the first or second slot number.

In some example embodiments, the first slot number is predefined.

In some example embodiments, the one or more frames have one or more frame numbers, wherein the one or more frame numbers comprise at least one of: a first frame number indicating the starting frame number for the repetitions of the PDCCH transmission, or a second frame number with the frame offset value with respect to the first frame number.

In some example embodiments, the starting frame number of the one or more frames is determined based on a predetermined periodicity and a reference frame.

In some example embodiments, the reference frame has a system frame number (SFN) 0 or 1.

In some example embodiments, the predetermined periodicity is associated with a number of frames for the repetitions of the PDCCH transmission, and the number of frames depends on the repetition factor.

In some example embodiments, the starting frame number is based on:

$$( {SFN}_{start} - {SFN}_{reference} ) mod ( M \times 2 ) = 0 ,$$

wherein SFNₛₜₐᵣₜ represents the starting frame number, SFN_{reference} represents a system frame number of the reference frame, and M represents the number of frames.

In some example embodiments, the repetition pattern is configured in two slots in each of the one or more frames, and the number of frames is determined as:

$$M = ⌈ \frac{N}{2} ⌉ ,$$

wherein M represents the number of frames, and N represents the repetition factor.

In some example embodiments, the first apparatus further comprises: means for receiving at least one configuration associated with the repetition pattern.

In some example embodiments, the PDCCH comprises Type0-PDCCH.

In some example embodiments, the first apparatus further comprises means for performing other operations in some example embodiments of the method 600 or the user device 110. In some example embodiments, the means comprises at least one processor; and at least one memory storing instructions that, when executed by the at least one processor, cause the performance of the first apparatus.

In some example embodiments, a second apparatus capable of performing any of the method 700 (for example, the network device 120 in FIG. 1) may comprise means for performing the respective operations of the method 700. The means may be implemented in any suitable form. For example, the means may be implemented in a circuitry or software module. The second apparatus may be implemented as or included in the network device 120 in FIG. 1.

In some example embodiments, the second apparatus comprises means for determining a repetition pattern associated with repetitions of a physical downlink control channel, PDCCH, transmission, wherein the repetition pattern is configured in at least one slot in one or more frames; and means for transmitting the repetitions of the PDCCH transmission based on the repetition pattern.

In some example embodiments, the repetition pattern is determined based on at least one of: a repetition factor, a starting symbol number, a starting slot number, a starting frame number, a slot offset value, a frame offset value, or an index of a synchronization signal block, SSB, beam.

In some example embodiments, the at least one slot has at least one predetermined slot number, wherein the at least one predetermined slot number comprises at least one of: a first slot number indicating a starting slot number for the repetitions of the PDCCH transmission, or a second slot number with the offset value with respect to the first slot number.

In some example embodiments, the repetition pattern is configured in slots having at least one of the first slot number or the second slot number in the one or more frames.

In some example embodiments, the repetition pattern is configured in a slot having the first or second slot number in each of the one or more frames.

In some example embodiments, the repetition pattern is configured in at least one symbol of the slot having the first or second slot number.

In some example embodiments, the first slot number is predefined.

In some example embodiments, the one or more frames have one or more frame numbers, wherein the one or more frame numbers comprise at least one of: a first frame number indicating the starting frame number for the repetitions of the PDCCH transmission, or a second frame number with the frame offset value with respect to the first frame number.

In some example embodiments, the starting frame number of the one or more frames is determined based on a predetermined periodicity and a reference frame.

In some example embodiments, the reference frame has a system frame number (SFN) 0 or 1.

In some example embodiments, the predetermined periodicity is associated with a number of frames for the repetitions of the PDCCH transmission, and the number of frames depends on the repetition factor.

In some example embodiments, the starting frame number is determined based on:

$$( {SFN}_{start} - {SFN}_{reference} ) mod ( M \times 2 ) = 0 ,$$

wherein SFNₛₜₐᵣₜ represents the starting frame number, SFN_{reference} represents a system frame number of the reference frame, and M represents the number of frames.

In some example embodiments, the repetition pattern is configured in two slots in each of the one or more frames, and the number of frames is determined as:

$$M = ⌈ \frac{N}{2} ⌉ ,$$

wherein M represents the number of frames, and N represents the repetition factor.

In some example embodiments, the second apparatus further comprises: means for transmitting at least one configuration associated with the repetition pattern.

In some example embodiments, the PDCCH comprises Type0-PDCCH.

In some example embodiments, the second apparatus further comprises means for performing other operations in some example embodiments of the method 700 or the network device 120. In some example embodiments, the means comprises at least one processor; and at least one memory storing instructions that, when executed by the at least one processor, cause the performance of the second apparatus.

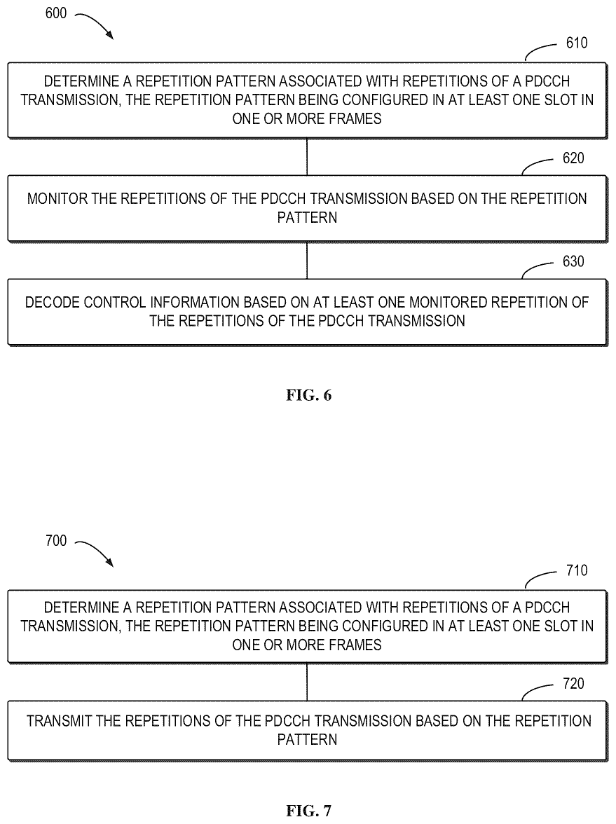

FIG. 8 is a simplified block diagram of a device 800 that is suitable for implementing example embodiments of the present disclosure. The device 800 may be provided to implement a communication device, for example, the user device 110 or the network device 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 1 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

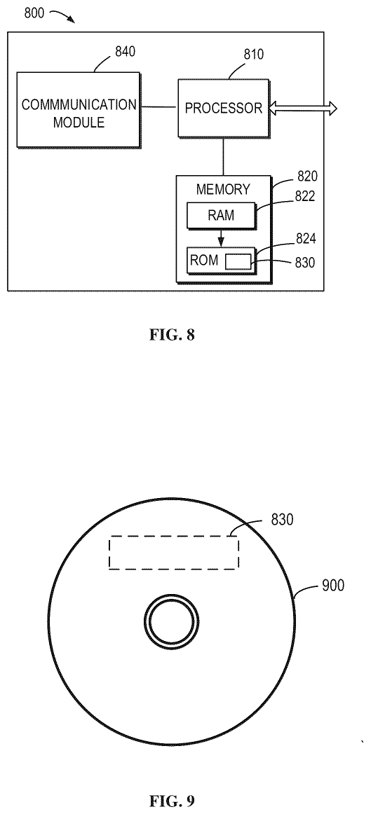

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server. In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A user device comprising:
at least one processor; and
at least one memory storing instructions that, when executed by the at least one processor, cause the user device at least to:
determine a repetition pattern associated with repetitions of a physical downlink control channel, PDCCH, transmission, wherein the repetition pattern is configured in at least one slot in one or more frames;
monitor the repetitions of the PDCCH transmission based on the repetition pattern; and
decode control information based on at least one monitored repetition of the repetitions of the PDCCH transmission.

2. The user device of claim 1, wherein the repetition pattern is determined based on at least one of:
a repetition factor,
a starting symbol number, a starting slot number,
a starting frame number, a slot offset value,
a frame offset value, or
an index of a synchronization signal block, SSB, beam.

3. The user device of claim 2, wherein the at least one slot has at least one slot number, wherein the at least one slot number comprises at least one of:
a first slot number indicating the starting slot number for the repetitions of the PDCCH transmission, or
a second slot number with the slot offset value with respect to the first slot number.

4. The user device of claim 3, wherein the repetition pattern is configured in slots having at least one of the first or second slot number in the one or more frames.

5. The user device of claim 3, wherein the repetition pattern is configured in a slot having the first or second slot number in each of the one or more frames.

6. The user device of claim 5, wherein the repetition pattern is configured in at least one symbol of the slot having the first or second slot number.

7. The user device of claim 3, wherein the first slot number is predefined.

8. A method comprising:
determining a repetition pattern associated with repetitions of a physical downlink control channel, PDCCH, transmission, wherein the repetition pattern is configured in at least one slot in one or more frames;
monitoring the repetitions of the PDCCH transmission based on the repetition pattern; and
decoding control information based on at least one monitored repetition of the repetitions of the PDCCH transmission.

9. The method of claim 8, wherein the repetition pattern is determined based on at least one of:
a repetition factor,
a starting symbol number, a starting slot number,
a starting frame number, a slot offset value,
a frame offset value, or
an index of a synchronization signal block, SSB, beam.

10. The method of claim 9, wherein the at least one slot has at least one slot number, wherein the at least one slot number comprises at least one of:
a first slot number indicating the starting slot number for the repetitions of the PDCCH transmission, or
a second slot number with the slot offset value with respect to the first slot number.

11. The method of claim 10, wherein the repetition pattern is configured in slots having at least one of the first or second slot number in the one or more frames.

12. The method of claim 10, wherein the repetition pattern is configured in a slot having the first or second slot number in each of the one or more frames.

13. The method of claim 12, wherein the repetition pattern is configured in at least one symbol of the slot having the first or second slot number.

14. The method of claim 10, wherein the first slot number is predefined.

15. A non-transitory computer readable medium comprising program instructions for causing an apparatus to perform at least:
determining a repetition pattern associated with repetitions of a physical downlink control channel, PDCCH, transmission, wherein the repetition pattern is configured in at least one slot in one or more frames;
monitoring the repetitions of the PDCCH transmission based on the repetition pattern; and
decoding control information based on at least one monitored repetition of the repetitions of the PDCCH transmission.

16. The non-transitory computer readable medium of claim 15, wherein the repetition pattern is determined based on at least one of:
a repetition factor,
a starting symbol number, a starting slot number,
a starting frame number, a slot offset value,
a frame offset value, or
an index of a synchronization signal block, SSB, beam.

17. The non-transitory computer readable medium of claim 16, wherein the at least one slot has at least one slot number, wherein the at least one slot number comprises at least one of:
a first slot number indicating the starting slot number for the repetitions of the PDCCH transmission, or
a second slot number with the slot offset value with respect to the first slot number.

18. The non-transitory computer readable medium of claim 17, wherein the repetition pattern is configured in slots having at least one of the first or second slot number in the one or more frames.

19. The non-transitory computer readable medium of claim 17, wherein the repetition pattern is configured in a slot having the first or second slot number in each of the one or more frames.

20. The non-transitory computer readable medium of claim 19, wherein the repetition pattern is configured in at least one symbol of the slot having the first or second slot number.
